(19) United States
(12) Patent Application Publication
(10) Pub. No.: US 2017/0068427 A1
(43) Pub. Date: Mar. 9, 2017

(54) CONTROL METHOD, INFORMATION PROCESSOR APPARATUS AND STORAGE MEDIUM

(71) Applicant: FUJITSU LIMITED, Kawasaki-shi (JP)

(72) Inventors: Hiroki Yamada, Kawasaki (JP); Junya Yamaguchi, Yokohama (JP); Mai Takahashi, Ota (JP); Hiroshi Fujino, Fuchu (JP)

(21) Appl. No.: 15/254,530

(22) Filed: Sep. 1, 2016

(30) Foreign Application Priority Data
Sep. 7, 2015 (JP) 2015-175950

(51) Int. Cl. G06F 3/0484; G09G 5/38; G06F 3/0481

(52) U.S. Cl. CPC G06F 3/04845; G06F 3/04817; G09G 5/38

(57) ABSTRACT

A control method executed by a computer having a display that has at least a first display region and a second display region, a plurality of icons being displayed at least in the second display region, includes changing a display surface area of a screen displayed in the first display region in a width direction parallel to an axis on which at least the plurality of icons are aligned, while the first display region maintains a state of abutting the second display region when a change instruction to change the display surface area of the first display region is received; and displaying the plurality of icons displayed in the second display region so as to be displayed inside the second display region which corresponds to the length in the width direction of the screen displayed in the first display region, in response to the change of the display surface area.

### CROSS-REFERENCE TO RELATED APPLICATION

This application is based upon and claims the benefit of priority of the prior Japanese Patent Application No. 2015-175950, filed on Sep. 7, 2015, the entire contents of which are incorporated herein by reference.

### FIELD

The embodiments discussed herein relate to a control method, an information processor apparatus, and a storage medium.

### BACKGROUND

In recent years, there has been a wide variety of sizes of mobile terminals with touch panels and mobile terminals with large touch panels are very popular. While a user usually operates the large touch panel with both hands, the user may also want to temporarily operate the large touch panel with one hand while holding a bag in the other hand or while doing other work at the same time. During single hand operation, the mobile terminal is held and operated with the same hand and the user is not able to perform operations in areas that are not able to be reached with a finger.

Accordingly, a technique is known for improving single hand operability by causing the entire screen to be subjected to parallel movement downwards for user interface components present in the longitudinal direction of the screen that is not able to be reached with a single hand. For example, Japanese Laid-open Patent Publication No. 2014-2756 is disclosed as related art.

Operability is improved in the above technique by causing the screen to move downward. However, in the case of a right-handed user, for example, although the fingers of the user are able to reach the upper right of the screen, the fingers of the user are naturally unable to reach the upper left of the screen that is in the diagonally opposite corner from the hand holding the mobile terminal. Thus, there is still a region that is not able to be operated with a single hand on the screen of the mobile terminal and it would be difficult to say that operability is improved with this technique.

### SUMMARY

According to an aspect of the invention, a control method executed by a computer having a display that has at least a first display region and a second display region, wherein a plurality of icons are displayed at least in the second display region, the method includes changing a display surface area of a screen displayed in the first display region in a width direction parallel to an axis on which at least the plurality of icons are aligned, while the first display region maintains a state of abutting the second display region when a change instruction to change the display surface area of the first display region is received; and displaying the plurality of icons displayed in the second display region so as to be displayed inside the second display region which corresponds to the length in the width direction of the screen displayed in the first display region, in response to the change of the display surface area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a view for explaining an example of a screen transition on a smartphone according to a first embodiment;

FIG. 2 is a view for explaining an example of a hardware configuration of the smartphone according to the first embodiment;

FIG. 3 is a functional block diagram for explaining a functional configuration of the smartphone according to the first embodiment;

FIG. 4 is a view for explaining a screen movement in the Y-axis direction;

FIG. 5 is a view for explaining a screen movement in the X-axis direction;

FIG. 6 is a view for explaining the rearrangement of icons;

FIG. 7 is a flow chart of a processing flow; and

FIG. 8 is a view for explaining an example of a screen transition during horizontal orientation.

### DESCRIPTION OF EMBODIMENTS

Embodiments of a display device, a display method, and a display program disclosed herein are described in detail with reference to the drawings. The present disclosure is not limited to the embodiments disclosed herein.

### First Embodiment

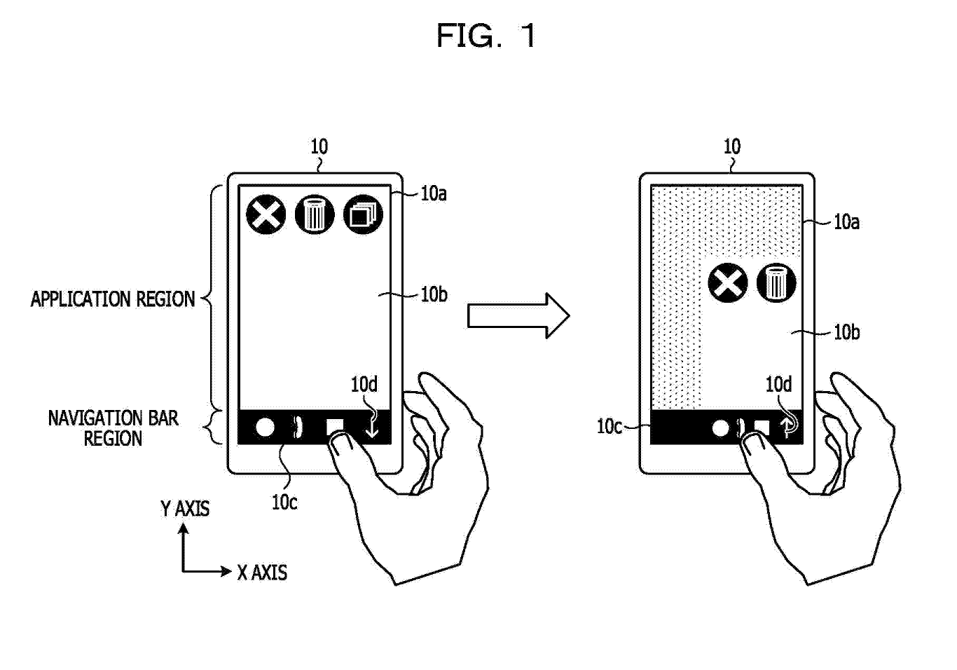

FIG. 1 is a view for explaining an example of a screen transition on a smartphone 10 according to a first embodiment. A smartphone 10 depicted in FIG. 1 is an example of a display device having a touch panel for displaying a screen in a display region. While the smartphone 10 is discussed herein as an example, similar processing is possible for another display device such as a personal data assistant (PDA) or tablet having a touch panel.

As illustrated in FIG. 1, the smartphone 10 has a touch panel for displaying a screen 10a. The screen 10a displayed on the touch panel has an application region 10b in which icons of various applications are displayed, and a navigation bar region 10c in which icons with a high usage frequency are displayed. Examples of icons with a high usage frequency include a communication icon for sending and receiving calls, an email icon for displaying an email screen, and a home icon for transitioning to a home screen.

A parallel movement icon 10d for executing parallel movement of the screen displayed in the application region 10b, is displayed in the navigation bar region 10c. In the following description, a screen displayed in the application region 10b may be simply described as the application region 10b, and a screen displayed in the navigation bar region 10c may be simply described as the navigation bar region 10c.

The exemplary screen depicted in the left side in FIG. 1 is, for example, a home screen which is displayed by an operating system and the like and which is a screen that includes user interface components and the like. The settings of the icons displayed in each region may be changed as desired. In the present embodiment, the Y axis is depicted as the longitudinal direction of the smartphone 10 and the X axis is depicted as the transverse direction of the smartphone 10 as an example.

In this state, the smartphone 10 causes the screen to move in a predetermined direction along a first axis and a predetermined direction along a second axis in the display region 10a when a screen movement instruction is received. That is, the smartphone 10 executes movement along both the X and Y axes, that is, bi-axial movement, of the displayed screen.

For example, the smartphone 10 causes parallel movement of the screen of the application region 10b in the longitudinal direction and in the transverse direction, as illustrated on the right side in FIG. 1, when the parallel movement icon 10d inside the navigation bar region 10c is selected. Moreover, the smartphone 10 rearranges the icons inside the navigation bar region 10c in accordance with the width in the transverse direction of the application region 10b as illustrated on the right side in FIG. 1.

In doing so, the user interface of the icons and the like displayed in the upper left that is the diagonally opposite corner with regard to the hand holding the smartphone 10, can be operated with the hand holding the smartphone 10. That is, the operability can be improved.

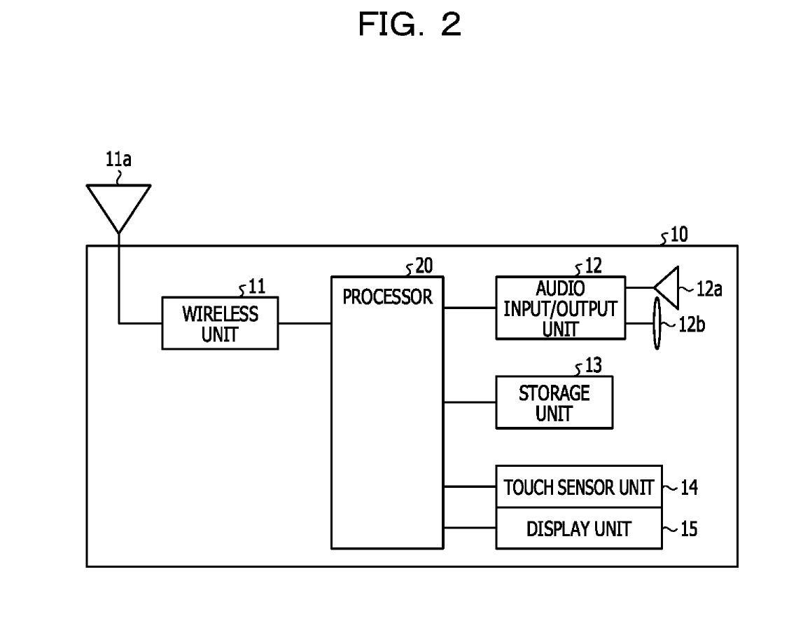

FIG. 2 is a view for explaining an example of a hardware configuration of the smartphone 10 according to the first embodiment. As illustrated in FIG. 2, the smartphone 10 includes a wireless unit 11, an audio input/output unit 12, a storage unit 13, a touch sensor unit 14, a display unit 15, and a processor 20. The hardware depicted here is merely an example and other hardware such as an acceleration sensor and the like may be included.

The wireless unit 11 uses an antenna 11a to perform communication with another smartphone or a base station and the like. The audio input/output unit 12 is a device for executing inputs and outputs of sound and the like. The audio input/output unit 12, for example, outputs various sounds from a speaker 12a and collects various sounds from a microphone 12b.

The storage unit 13 is a storage device for storing various types of data and programs. The storage unit 13 stores, for example, a program and/or a DB for executing the following processes. The touch sensor unit 14 and the display unit 15 operate together to realize a touch panel. The touch sensor unit 14 detects the contact of an indicating body such as a finger on the display unit 15. The display unit 15 displays various types of information such as a screen and the like.

The processor 20 is a processing unit for managing the processes of the entire smartphone 10. The processor 20 may be a central processing unit (CPU) for example. For example, the processor 20 executes an operating system (OS). The processor 20 reads a program stored in the storage unit 13 such as a non-volatile memory, expands the program into a volatile memory, and executes a process for running the processes described below.

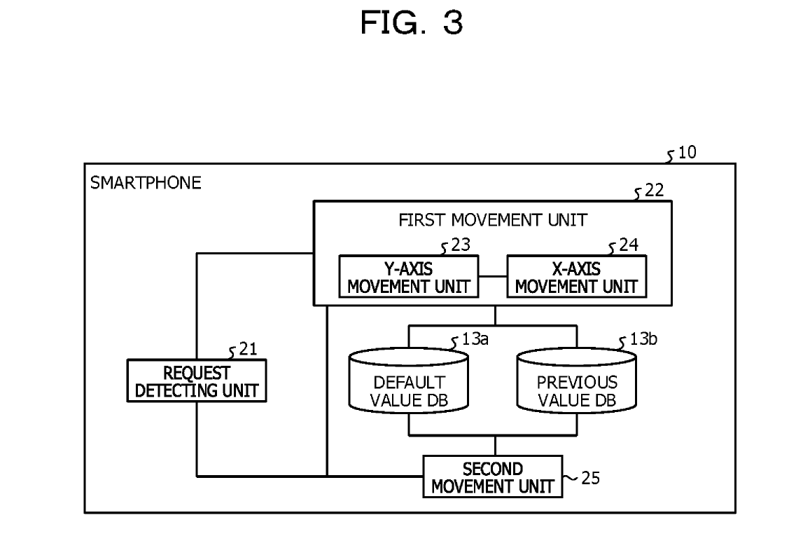

FIG. 3 is a functional block diagram for explaining a functional configuration of the smartphone 10 according to the first embodiment. As illustrated in FIG. 3, the smartphone 10 includes a default value DB 13a, a previous value DB 13b, a request detecting unit 21, a first movement unit 22, and a second movement unit 25.

The default value DB 13a and the previous value DB 13b are databases stored in the storage unit 13. The request detecting unit 21, the first movement unit 22, and the second movement unit 25 are examples of electronic circuits included in the processor 20 or examples of processes executed by the processor 20.

The default value DB 13a is a database for storing information of a previously set movement destination (default movement values) for a screen and that is a movement destination when executing bi-axial movement. Specifically, the default value DB 13a stores coordinates and the like indicating the position for causing the application region 10b to be moved downward (negative direction on the Y-axis) when the parallel movement icon 10d is selected. The default value DB 13a stores coordinates and the like that indicate the position for causing the application region 10b to be moved to the right (positive direction on the X-axis) or the position for causing the application region 10b to be moved to the left (negative direction on the X-axis). The default value DB 13a stores coordinates and the like that indicate a position that is rearranged accompanying the movement of the application region 10b.

The previous value DB 13b is a database for storing information of a movement destination for a screen designated by a user operation and that is a movement destination when executing bi-axial movement. Specifically, the previous value DB 13b stores coordinates and the like that indicate the previous position when the application region 10b has been moved downward. The default value DB 13a stores coordinates and the like that indicate the previous position when the application region 10b has been moved to the right or the previous position when the application region 10b has been moved to the left. The previous value DB 13b stores coordinates and the like indicating the position of an icon inside the navigation bar region 10c that has been rearranged accompanying the movement of the application region 10b.

The request detecting unit 21 is a processing unit for receiving requests for executing bi-axial movement of the screen or requests for returning the screen to the original position after the bi-axial movement. Specifically, the request detecting unit 21 outputs a movement instruction in the Y-axis direction when the selection of the parallel movement icon 10d is received on the touch panel to the first movement unit 22. The request detecting unit 21 cancels the bi-axial movement and returns the icons inside the application region 10b and the navigation bar region 10c to the original state when the parallel movement icon 10d displayed on the touch panel is selected after the bi-axial movement.

The first movement unit 22 has a Y-axis movement unit 23 and an X-axis movement unit 24 and is a processing unit for moving the application region 10b in the Y-axis direction and the X-axis direction. That is, the first movement unit 22 executes the bi-axial movement of the application region 10b when an instruction for bi-axial movement is received from the request detecting unit 21.

The Y-axis movement unit 23 is a processing unit for moving the application region 10b downward, that is, in the negative direction of the Y axis. Specifically, the Y-axis movement unit 23 refers to the previous value DB 13b when a bi-axial movement instruction is received. When Y-axis position information is stored in the previous value DB 13b, the Y-axis movement unit 23 then performs parallel movement of the region of the application region 10b to the position specified by the position information. At this time, the Y-axis movement unit 23 performs parallel movement on the application region 10b in the Y-axis direction so that the uppermost part of the application region 10b is positioned at the position specified by the position information.

Conversely, the Y-axis movement unit 23 reads a default value from the default value DB 13a when no Y-axis position information is stored in the previous value DB 13b. The Y-axis movement unit 23 then performs parallel movement of the region of the application region 10b to the position specified by the read default value. At this time, the Y-axis movement unit 23 performs the parallel movement on the application region 10b so that the uppermost part of the application region 10b is positioned at the position specified in accordance with the position information.

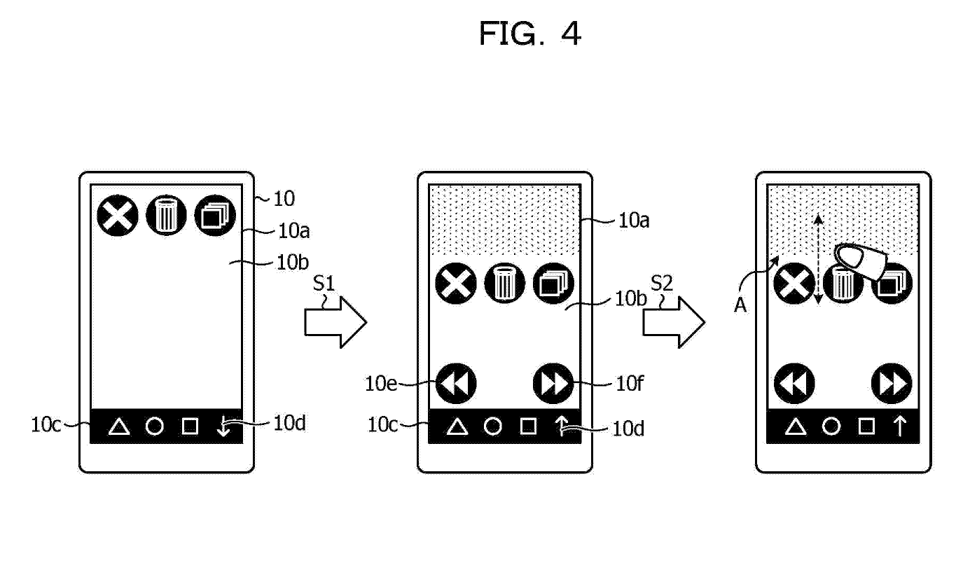

The following is an explanation of movement in the Y-axis direction of the application region 10b. FIG. 4 is a view for explaining a screen movement in the Y-axis direction. Initial movement when no position information is stored in the previous value DB 13b will be explained. As illustrated in FIG. 4, the Y-axis movement unit 23 causes the application region 10b to slide downward so that the uppermost part of the application region 10b reaches the default movement value when the parallel movement icon 10d is selected (S1). At this time, the navigation bar region 10c does not move.

The Y-axis movement unit 23 displays a left operation icon 10e and a right operation icon 10f in the application region 10b when the application region 10b is caused to slide downward. Further, the Y-axis movement unit 23 vertically inverts the parallel movement icon 10d inside the navigation bar region 10c. The left operation icon 10e is an icon for causing the application region 10b to be moved to the left. The right operation icon 10f is an icon for causing the application region 10b to be moved to the right. When the parallel movement icon 10d is selected at this stage, the downward sliding of the application region 10b is canceled and the request detecting unit 21 returns the application region 10b to the original state.

The Y-axis movement unit 23 then receives an operation on a border A between the application region 10b after the sliding and a non-display region and is able to cause the border A to be moved (S2). For example, the user touches the border A and moves the border A up and down to cause the application region 10b to slide to any position, thereby changing the height of the application region 10b as desired.

Next, when the left operation icon 10e or the right operation icon 10f is selected by the user, the Y-axis movement unit 23 instructs the start of processing by the X-axis movement unit 24. The Y-axis movement unit 23 stores, in the previous value DB 13b, the position information on the Y axis of the border A when the left operation icon 10e or the right operation icon 10f is selected.

Returning to FIG. 3, the X-axis movement unit 24 is a processing unit for performing parallel movement of the application region 10b to the right, that is, in the positive direction of the X axis, or for performing parallel movement of the application region 10b to the left, that is, in the negative direction of the X axis.

Specifically, the X-axis movement unit 24 refers to the previous value DB 13b when an instruction for starting processing is received from the Y-axis movement unit 23. When the X-axis position information is stored in the previous value DB 13b, the X-axis movement unit 24 then performs parallel movement on the region of the application region 10b to the position specified by the position information. At this time, the X-axis movement unit 24 performs parallel movement on the application region 10b in the X-axis direction so that the right edge or the left edge of the application region 10b is positioned at the position specified by the position information.

Conversely, when no X-axis position information is stored in the previous value DB 13b, the X-axis movement unit 24 reads a default value from the default value DB 13a. The X-axis movement unit 24 then performs parallel movement of the region of the application region 10b to the position specified by the read default value. At this time, the X-axis movement unit 24 performs parallel movement on the application region 10b in the X-axis direction so that the right edge or the left edge of the application region 10b is positioned at the position specified by the position information.

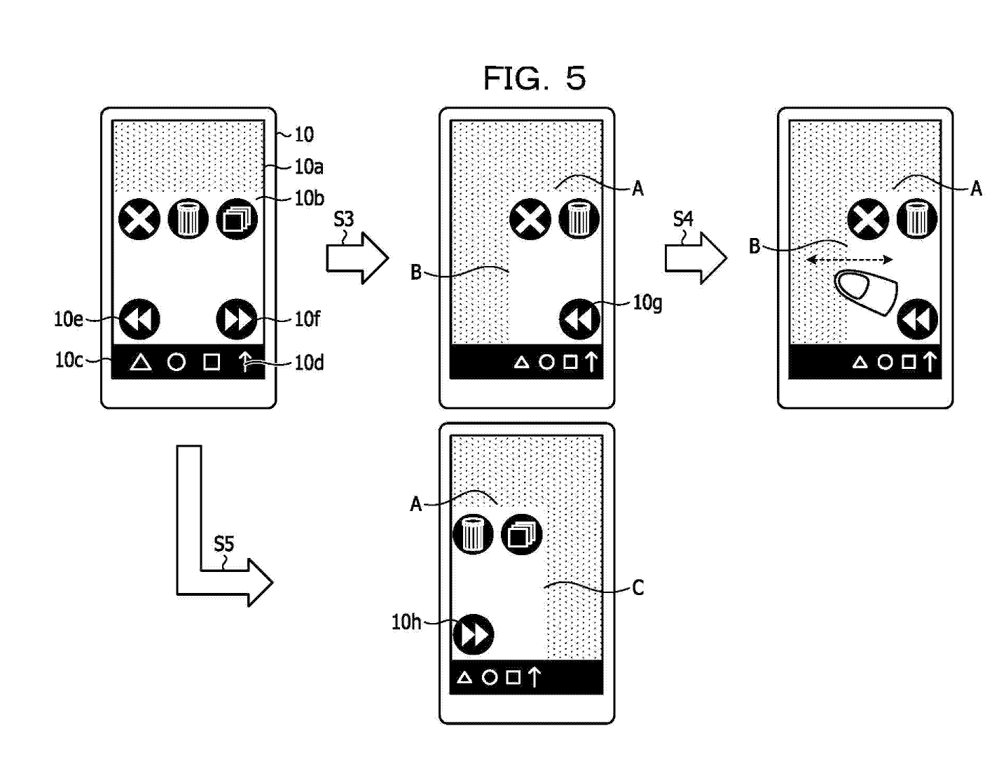

The following is an explanation of movement in the X-axis direction of the application region 10b. FIG. 5 is a view for explaining a screen movement in the X-axis direction. Initial movement when no position information is stored in the previous value DB 13b will be explained. As illustrated in FIG. 5, the X-axis movement unit 24 causes the application region 10b to slide to the right so that the left edge of the application region 10b reaches the default movement value when the right operation icon 10f is selected (S3). At this time, the navigation bar region 10c does not move.

The X-axis movement unit 24 does not display the left operation icon 10e when sliding the application region 10b to the right. The X-axis movement unit 24 inverts the display of the right operation icon 10f to a left operation icon 10g. When the left operation icon 10g is selected, the application region 10b is returned to the state before the movement in the X-axis direction, that is, to the initial state in FIG. 5. When the parallel movement icon 10d is selected at this stage, the request detecting unit 21 returns the application region 10b to the initial state or to the state before the movement in the horizontal direction.

Moreover, the X-axis movement unit 24 receives an operation on a border B between the application region 10b after the sliding and the non-display region and is able to cause the border B to be moved (S4). For example, the user touches the border B and moves the border B to the left and right to cause the application region 10b to slide to any position, thereby allowing the width of the application region 10b to be changed as desired.

Similarly, the X-axis movement unit 24 causes the application region 10b to slide to the left so that the right edge of the application region 10b reaches the default movement value when the left operation icon 10e is selected (S5). At this time, the navigation bar region 10c does not move. The X-axis movement unit 24 does not display the right operation icon 10f when sliding the application region 10b to the left. The X-axis movement unit 24 then inverts the display of the left operation icon 10e to a right operation icon 10h. When the right operation icon 10h is selected, the application region 10b is returned to the state before the movement in the X-axis direction, that is, to the initial state in FIG. 5. Moreover, the X-axis movement unit 24 receives an operation on a border C between the application region 10b after the sliding and the non-display region and is able to cause the border C to be moved.

When the position of the border B or the border C is defined, the X-axis movement unit 24 stores the position information of the defined position in the previous value DB 13b. For example, when the operation on the border B or the border C does not have a predetermined time period, when another icon is selected, or when a defining operation such as two consecutive touches on the touch panel is performed, the X-axis movement unit 24 determines that the position of border B or the border C is defined. The X-axis movement unit 24 instructs the second movement unit 25 to start processing when the position of the border B or the border C is defined.

The second movement unit 25 is a processing unit for rearranging the icons inside the navigation bar region 10c accompanying the movement of the application region 10b. Specifically, the second movement unit 25 rearranges the icons inside the navigation bar region 10c to be contained inside an area having a width that is the same as the X-axis width of the application region 10b.

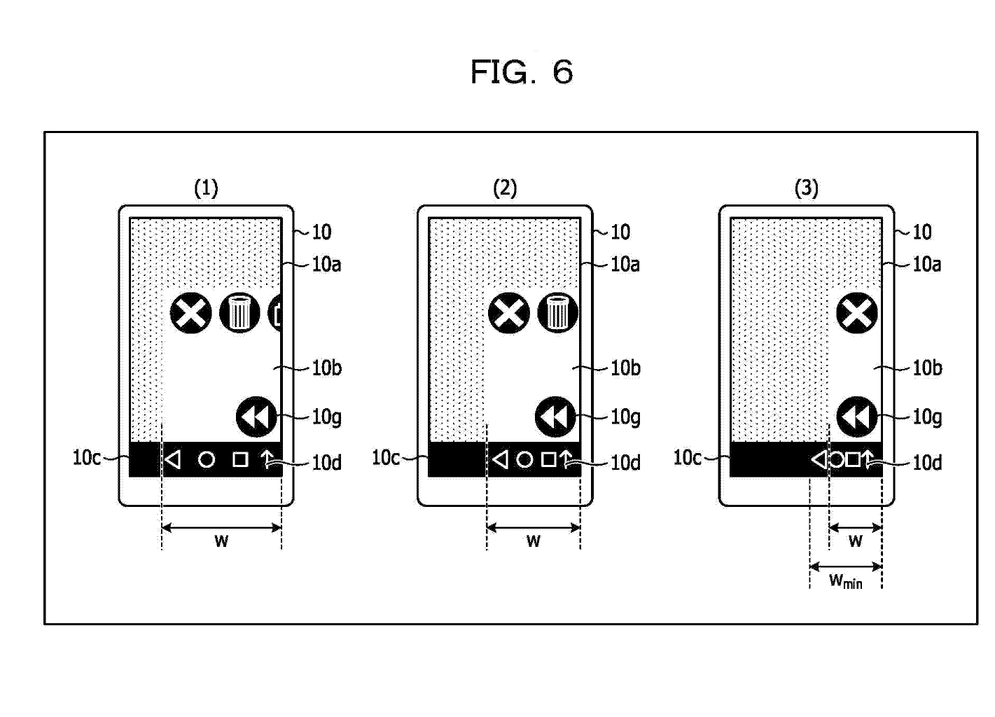

The following is a detailed explanation of the rearrangement of the icons inside the navigation bar region 10c. FIG. 6 is a view for explaining the rearrangement of icons. Here, the X-axis width of the application region 10b is depicted as “w”, the width of the navigation bar region 10c is depicted as “wₙₐᵥᵢ”, and a threshold is depicted as “wₘᵢₙ”.

As illustrated in (1) and (2) in FIG. 6, the second movement unit 25 sets the X-axis width “w” to be the same as the width “wₙₐᵥᵢ” of the navigation bar region 10c if the X-axis width “w” of the application region 10b is equal to or greater than the threshold “wₘᵢₙ”. The second movement unit 25 then rearranges the icons so that the icons are contained inside the area of the X-axis width “w”.

As illustrated in (3) in FIG. 6, the second movement unit 25 sets the width “wₙₐᵥᵢ” of the navigation bar region 10c to be the same as the threshold “wₘᵢₙ” if the X-axis width “w” of the application region 10b is less than the threshold “wₘᵢₙ”. The second movement unit 25 then rearranges the icons so that the icons are contained inside the area of the threshold “wₘᵢₙ”.

The second movement unit 25 is able to automatically change the threshold “wₘᵢₙ” in accordance with the number of icons. For example, when the number of icons displayed in the navigation bar region 10c is “n” and the horizontal width for pressing one icon is “w_{con}”, the second movement unit 25 calculates the threshold as “wₘᵢₙ=n×w_{con}”.

The second movement unit 25 then executes the control as described in FIG. 6 in accordance with the threshold “wₘᵢₙ” calculated using the number of icons. When the width “wₙₐᵥᵢ” of the navigation bar region 10c is defined, the second movement unit 25 may also store the defined “wₙₐᵥᵢ” in the previous value DB 13b. When the parallel movement icon 10d is selected at this stage, the request detecting unit 21 returns the application region 10b to the initial state or to the state before the movement in the horizontal direction.

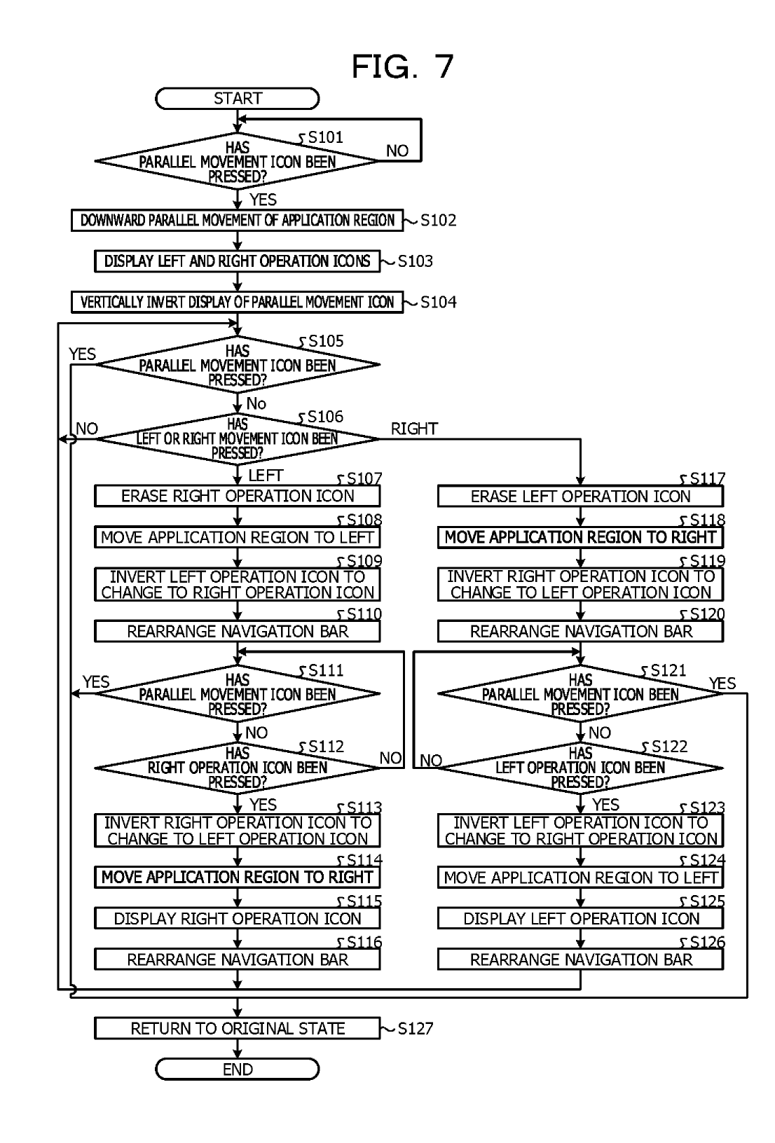

FIG. 7 is a flow chart of a processing flow. As illustrated in FIG. 7, when the selection of the parallel movement icon 10d is detected by the request detecting unit 21 (S101: Yes), the Y-axis movement unit 23 performs downward parallel movement of the application region 10b (S102).

Next, the Y-axis movement unit 23 displays the left and right operation icons on the screen of the touch panel (S103). That is, the Y-axis movement unit 23 displays the left operation icon 10e and the right operation icon 10f on the screen. The Y-axis movement unit 23 then vertically inverts the display of the parallel movement icon 10d (S104).

Next, if the inverted parallel movement icon 10d is not selected (S105: No) and the left operation icon 10e is selected (S106: Left), the X-axis movement unit 24 erases the display of the right operation icon 10f (S107).

The X-axis movement unit 24 performs parallel movement to move the application region 10b to the left (S108), and inverts the display of the left operation icon 10e to change the display to the right operation icon 10h (S109). The second movement unit 25 then rearranges the icons displayed in the navigation bar region 10c (S110).

Next, if the inverted parallel movement icon 10d is not selected (S111: No) and the right operation icon 10h is selected (S112: Yes), the X-axis movement unit 24 inverts the right operation icon 10h and displays the original left operation icon 10e (S113).

The X-axis movement unit 24 then performs parallel movement to move the application region 10b to the right (S114) and displays the right operation icon 10f (S115). The second movement unit 25 then rearranges the icons displayed in the navigation bar region 10c (S116). Thereafter, the processing from S105 is repeated. If the right operation icon 10h is not selected in S112 (S112: No), the processing from S111 is repeated.

Conversely, if the inverted parallel movement icon 10d is not selected (S105: No) and the right operation icon 10f is selected (S106: Right), the X-axis movement unit 24 erases the display of the left operation icon 10e (S117).

Next, the X-axis movement unit 24 performs parallel movement to move the application region 10b to the right (S118), and inverts the display of the right operation icon 10f to change the display to the left operation icon 10g (S119). The second movement unit 25 then rearranges the icons displayed in the navigation bar region 10c (S120).

Next, if the inverted parallel movement icon 10d is not selected (S121: No) and the left operation icon 10g is selected (S122: Yes), the X-axis movement unit 24 inverts the left operation icon 10g and displays the original right operation icon 10f (S123).

Thereafter, the X-axis movement unit 24 performs parallel movement to move the application region 10b to the left (S124) and displays the left operation icon 10e (S125). The second movement unit 25 then rearranges the icons displayed in the navigation bar region 10c (S126). Thereafter, the processing from S105 onward is repeated. If the left operation icon 10g is not selected in S122 (S122: No), the processing from S121 is repeated.

When the request detecting unit 21 detects that the inverted parallel movement icon 10d has been selected (S105: Yes), the parallel movement is canceled and the state is returned to the original state (S127). Similarly, if the inverted parallel movement icon 10d is selected in S111 (S111: Yes), or if the inverted parallel movement icon 10d is selected in S121 (S121: Yes), the request detecting unit 21 returns the state to the original state (S127).

In this way, the smartphone 10 according to the first embodiment is able to perform parallel movement on the application region 10b for displaying interface components such as icons in the Y-axis direction and the X-axis direction. As a result, the user interface such as the icons displayed in the diagonally opposite corner with regard to the hand holding the smartphone 10, can be operated with the hand holding the smartphone 10.

The smartphone 10 allows the user to change the position subjected to parallel movement whereby the user is able to display the application region 10b at a position suitable to the user and convenience for the user is improved.

The smartphone 10 stores positions set once by the user, and when the application region 10b is moved thereafter, the application region 10b can be moved to the set position. Therefore, the user can omit performing an operation for resetting the position of the application region 10b.

The smartphone 10 is able to adjust the width of the navigation bar region 10c in accordance with the number of icons inside the navigation bar region 10c. Therefore, a state in which the icons become very small such that it is difficult to press the icons can be avoided.

### Embodiment 2

While the first embodiment describes a case in which the orientation of the smartphone 10 is in the so-called vertical orientation, the embodiments are not limited to this state and the processing can be carried out in the same way even when the orientation of the smartphone 10 is in the so-called horizontal orientation.

An example of performing bi-axial movement of the application region 10b when the orientation of the smartphone 10 is the horizontal orientation is discussed in the second embodiment. In the second embodiment, the X axis is the longitudinal direction of the smartphone 10 and the Y axis is the transverse direction of the smartphone 10. An example of moving in the Y-axis direction after first being moved in the X-axis direction is described in the second embodiment. As a result, the parallel movement icon 10d takes on a rightward orientation and a leftward orientation instead of the downward orientation and the upward orientation. While the displays of the left and right operation icons are changed to up and down operation icons, the contents of the processing are the same.

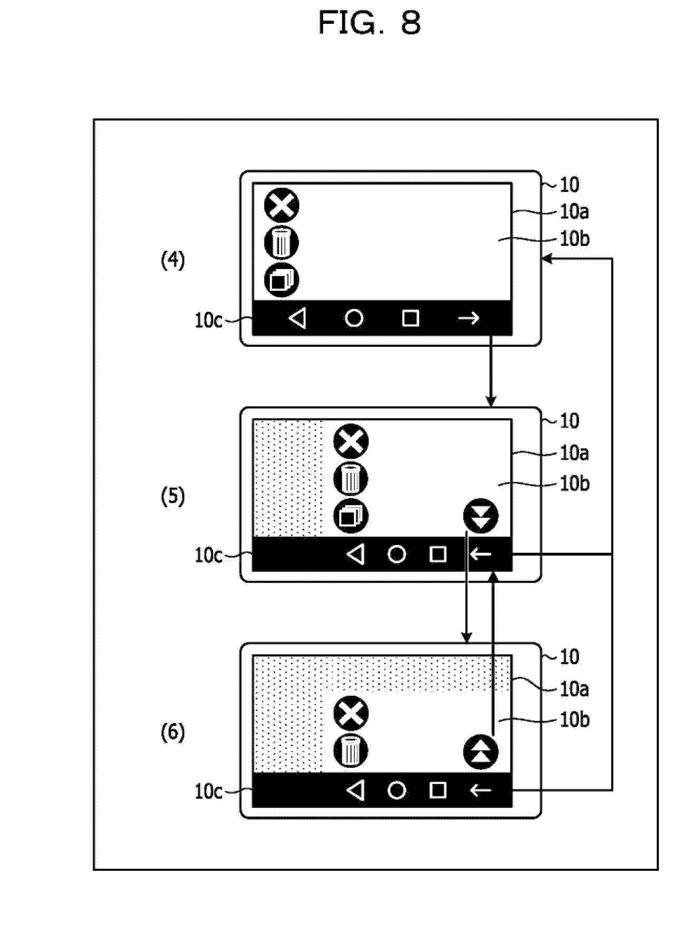

FIG. 8 is a view for explaining an example of a screen transition during horizontal orientation. The smartphone 10 illustrated in FIG. 8 displays the screen 10a having the application region 10b and the navigation bar region 10c (see (4) in FIG. 8). The parallel movement icon for executing a parallel movement of the screen displayed in the application region 10b, is displayed in the navigation bar region 10c. The parallel movement icon is a rightward orientation icon which is different from the first embodiment.

When the parallel movement icon is selected, the X-axis movement unit 24 in the smartphone 10 then performs parallel movement to move the application region 10b to the right (see (5) in FIG. 8). At this time, the second movement unit 25 rearranges the icons in the navigation bar region 10c to conform to the width in the X-axis direction of the application region 10b. The X-axis movement unit 24 changes the orientation of the parallel movement icon from the right to the left. The X-axis movement unit 24 displays a downward movement icon in the application region 10b.

When the downward movement icon is selected, the Y-axis movement unit 23 in the smartphone 10 then performs parallel movement to move the application region 10b downward (see (6) in FIG. 8). At this time, the X-axis movement unit 24 inverts the orientation of the downward movement icon and displays an upward movement icon.

Conversely, when the parallel movement icon is selected during the state depicted in (5), the request detecting unit 21 returns the display of the application region 10b to the state depicted in (4) which is the original state. When the parallel movement icon is selected during the state depicted in (6), the request detecting unit 21 returns the display of the application region 10b to the state depicted in (4) which is the original state. When the upward movement icon is selected during the state depicted in (6), the request detecting unit 21 returns the display of the application region 10b to the state depicted in (5) which is the state before the movement.

In this way, the smartphone 10 is able to perform parallel movement on the application region 10b for displaying interface components such as icons in the Y-axis direction and the X-axis direction even when the smartphone 10 is in the horizontal orientation without being limited to the vertical orientation. As a result, the user interface such as the icons displayed in the diagonally opposite corner with regard to the hand holding the smartphone 10, can be operated with the hand holding the smartphone 10.

### Embodiment 3

Although embodiments of the present disclosure have been described up to this point, the present disclosure may be implemented in various different modes other than the embodiments of the present disclosure described above.

An example in which the display was moved in the X-axis direction after being moved in the Y-axis direction has been described in the first embodiment. An example in which the display was moved in the Y-axis direction after being moved in the X-axis direction has been described in the second embodiment. However, the present disclosure is not limited as such. For example, the sequence of the movements in the X axis and the Y axis may be carried out in any order and either movement may be carried out first.

When moving, for example, the display to the previous position, the smartphone 10 may move the display to the previous position in the Y-axis direction and then the X-axis direction in two steps, or move the display to the previous position in one step.

The sizes of the application region 10b and the navigation bar region 10c are not limited to the sizes illustrated in the first and second embodiments, and may be changed as desired. The position of the navigation bar region 10c is similarly not limited to the positions illustrated in the first and second embodiments. For example, the application region 10b may be arranged on the upper side, the right side, or the left side.

The processing may be carried out in the same way even when the regions of the screen 10a are not separated and only the application region 10b is displayed. Specifically, only the processing of the first movement unit 22 is executed.

The constituent elements of the devices illustrated in FIG. 3 do not have to be configured physically as illustrated. That is, the elements may be distributed or integrated as desired. For example, the first movement unit 22 and the second movement unit 25 may be integrated. All or a part of the processing functionality implemented by the components may be performed by a CPU and a program that is analyzed and executed by the CPU, or may be implemented as hardware with wired logic.

Among the processing described in the present embodiment, all or some of the processing described as being conducted automatically may be conducted manually. Conversely, all or some of the processing described as being conducted manually may be conducted automatically using known methods. The procedures, the control procedures, the specific names, and information including various kinds of data and parameters that have been described in the specification and illustrated in the drawings may be altered, unless specified in particular.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method executed by a computer having a display that has at least a first display region and a second display region, wherein a plurality of icons are displayed at least in the second display region, the method comprising:
changing a display surface area of a screen displayed in the first display region in a width direction parallel to an axis on which at least the plurality of icons are aligned, while the first display region maintains a state of abutting the second display region when a change instruction to change the display surface area of the first display region is received; and
displaying the plurality of icons displayed in the second display region so as to be displayed inside the second display region which corresponds to the length in the width direction of the screen displayed in the first display region, in response to the change of the display surface area.

2. The control method according to claim 1,
wherein the changing includes moving the screen in the direction of the axis on which the icons are aligned and in a direction of the axis perpendicular to the axis on which the icons are aligned.

3. The control method according to claim 1,
wherein the changing includes rearranging the plurality of icons inside the second region so as to be contained inside the area of the width of the screen when, after the movement, the width of the screen displayed in the first display region is equal to or greater than a threshold in the direction of the axis on which the icons are aligned.

4. The control method according to claim 3,
wherein the changing includes rearranging the plurality of icons inside the second region so as to be contained inside the area of the threshold when, after the movement, the width of the screen displayed in the first display region is less than the threshold in the direction of the axis on which the icon is displayed.

5. The control method according to claim 1,
wherein the changing includes moving the screen displayed in the first display region while keeping the screen displayed in the second display region stationary.

6. The control method according to claim 3,
wherein the rearranging includes setting the width of the plurality of icons in the direction of the axis on which the icons are aligned, so as to be equal to or greater than a predetermined value determined based on the number of the plurality of icons.

7. The control method according to claim 6,
wherein the predetermined value is determined by multiplying a predetermined width set for one icon by the number of the plurality of icons.

8. The control method according to claim 1,
wherein the changing includes:
moving the screen displayed in the first display region in the direction of the axis perpendicular to the axis on which the icons are aligned in accordance with a first change instruction, and
moving the screen displayed in the first display region in the direction of the axis on which the icons are aligned in accordance with a second change instruction received subsequent to the first change instruction.

9. The control method according to claim 1, further comprising:
storing position information of a movement destination of the movement,
wherein the changing includes controlling so as to move the screen displayed in the first display region to a position corresponding to the stored position information when the change instruction is received again.

10. An information processor apparatus comprising:
a display that has at least a first display region and a second display region, wherein a plurality of icons are displayed at least in the second display region; and
a processor coupled to the memory and configured to:
change a display surface area of a screen displayed in the first display region in a width direction parallel to an axis on which at least the plurality of icons are aligned, while the first display region maintains a state of abutting the second display region when a change instruction to change the display surface area of the first display region is received, and
display the plurality of icons displayed in the second display region so as to be displayed inside the second display region which corresponds to the length in the width direction of the screen displayed in the first display region, in response to the change of the display surface area.

11. A non-transitory computer-readable storage medium storing a program that causes a processor included in a computer including a display that has at least a first display region and a second display region, wherein a plurality of icons are displayed at least in the second display region, to execute a process, the process comprising:
moving a display surface area of a screen displayed in the first display region in a width direction parallel to an axis on which at least the plurality of icons are aligned, while the first display region maintains a state of abutting the second display region when a change instruction to change the display surface area of the first display region is received; and
displaying the plurality of icons displayed in the second display region so as to be displayed inside the second display region which corresponds to the length in the width direction of the screen displayed in the first display region, in response to the change of the display surface area.
